(19) United States
(12) Patent Application Publication
(10) Pub. No.: US 2010/0327490 A1
(43) Pub. Date: Dec. 30, 2010

(54) Pneumatic Tire And Manufacturing Method Of The Same

(75) Inventors: Masaaki Ohara, Osaka-fu (JP); Takashi Nakatsuru, Osaka-fu (JP)

Correspondence Address: FISH & RICHARDSON P.C. (NY), P.O. BOX 1022, MINNEAPOLIS, MN, 55440-1022, US

(73) Assignee: Toyo Tire & Rubber Co., Ltd., Osaka-fu (JP)

(21) Appl. No.: 12/880,204

(22) Filed: Sep. 13, 2010

Related U.S. Application Data
(62) Division of application No. 11/842,444, filed on Aug. 21, 2007.

(30) Foreign Application Priority Data
Aug. 22, 2006 (JP) 2006-225733

(51) Int. Cl. B29D 30/06

(52) U.S. Cl. 264/319

(57) ABSTRACT

In a block pattern, transverse grooves 2 are provided that open to grounding edge in the tire width direction, at bottoms of said transverse grooves, protrusions 3 are provided that extend along the direction of said transverse grooves, said protrusions 3 have starting points in the center side C from the grounding edge T in a tire front view, and said protrusions have terminal points that go over said grounding edge T and in the outer side from said grounding edge T. Further, it is preferable that the protrusions 3 of said transverse grooves are provided with divided protrusions 4 that are formed dividedly in the center side from the grounding edge.

The description of this application claims benefit of priority based on Japanese Patent Application No. 2006-225733, the entire same contents of which are incorporated by reference herein.

### BACKGROUND OF THE INVENTION

1. Field of the Invention

The present invention relates to a pneumatic tire with a block pattern capable of inhibiting mud clogging of lug grooves in muddy grounds and the manufacturing method of the same, and in more detail, the present invention relates to a groove shape of a tread pattern of the pneumatic tire.

2. Description of the Prior Art

When driving an automobile on a muddy ground, we find that the grooves provided on a tread of the pneumatic tire are likely to be clogged with mud. Such mud clogging raises the problem in lug tires mainly used in tillage working vehicles and preventive measures have been proposed such as patent document 1 (Japanese Utility Laid-Open Publication No. Sho 60-118502) and 2 (Japanese Patent Laid-Open Publication No. Hei 10-230708).

This problem of mud clogging is treated as unimportant for the pneumatic tire with a block pattern used for a general automobile except for an agricultural vehicle. However, a passenger-vehicle does not run only on roads paved with asphalt and the passenger-vehicle sometimes runs muddy grounds or unpaved country roads on rainy days and therefore, it leaves the problem to be solved.

By the way, for the countermeasures for pinching by groove portions that gives rise to the problem in block tires for trucks or other working vehicles used in the fields of construction, for example, as shown in patent document 3 (Japanese Patent Laid-Open Publication No. Hei 11-180112), a technique of providing protrusions for preventing pinching at a main groove bottom with predetermined height is disclosed. Such protrusions for preventing pinching are helpful to some extent for preventing mud clogging and exhausting discharged mud.

However, the technique disclosed in the patent document 3 is nothing but the one for preventing pinching and it is not satisfactory to solely employ this technique in view of the difference of stones that are solid matters and mud that has fluidity.

### SUMMARY OF THE INVENTION

In order to solve the problem, that is, in order to prevent the mud from clogging at a lug groove in the above mentioned tire or to exhaust the clogged mud at a lug groove in the above mentioned tire, the present invention has the essential and main characteristics in that it relates to a pneumatic tire having block patterns with a plurality of blocks formed on a tire surface, wherein

said pneumatic tire is provided with transverse grooves that open to a grounding edge in the tire width direction, and is provided with protrusions that extend along the direction of said transverse grooves at bottoms of said transverse grooves, in a tire front view, said protrusions have starting points in the center side from a grounding edge, which go over said grounding edge and have terminal points in the outer side from said grounding edge.

As a manufacturing method of the pneumatic tire that has the above mentioned protrusions, it is preferable to arrange vent holes at each position of the tire mold that corresponds to the positions of the protrusions of the transverse grooves, and perform vulcanization molding of the pneumatic tire exhausting the residual air from said vent holes.

According to the pneumatic tire with the above mentioned protrusions of the present invention, even with a block tire, mud clogging can effectively be inhibited or clogged mud can effectively be exhausted, and therefore, driving on paved roads after driving on muddy grounds can restore traction performance immediately.

In particular, when the protrusions of the above mentioned transverse grooves are formed dividedly in the center side from the grounding edge, since the protrusions are likely to move more easily, especially, mud clogging is effectively inhibited and mud are effectively discharged.

Further, when the protrusions of the above mentioned transverse grooves are formed dividedly in the center side from the grounding edge as well as when the divided protrusions are formed in S-shapes, generation of cracks at a protrusion root that is likely to raise a problem in providing such short protrusions can effectively be inhibited.

In providing the above mentioned protrusions, according to the manufacturing method of the present invention, since ridge lines of the protrusion portion can be sharply formed in addition to preventing the bad appearance by the residual air, in the above mentioned protrusions of the pneumatic tire molded by the method of the present invention, the effect of inhibiting mud clogging and discharging the mud becomes even greater. In addition, when vent holes are provided at the position corresponding to the protrusions, spews are generated at the above mentioned protrusion portions and spews at the lug groove bottoms are hard to be cut. However, since the size of the spews is not highly visible when they are generated by making the pore diameters of the vent holes not greater than 1 mm, they are accepted in the market as they are.

### BRIEF DESCRIPTION OF THE DRAWINGS

FIG. 1 (A) is a front elevation view of a tread pattern of a pneumatic tire of the present invention.

FIG. 1 (B) is a cross-section view along the direction that the protrusion extends in the embodiment of FIG. 1 (A).

FIG. 1 (C) is a cross-section view taken along A-A′ in the embodiment of FIG. 1 (A).

FIG. 2 (A) is a front elevation view of a tread pattern of a pneumatic tire in another embodiment of the present invention.

FIG. 2 (B) is a cross-section view along the direction that the protrusion extends in the embodiment of FIG. 2 (A).

FIG. 3 is a front elevation view of a tread pattern of the pneumatic tire in another embodiment of the present invention.

FIG. 4 is a front elevation view of a tread pattern of the pneumatic tire in another embodiment of the present invention.

FIG. 5 (A) is a front elevation view (reference view) of a tread pattern with protrusions present that are not those of the present invention.

FIG. 5 (B) is a cross-section view along the direction that the protrusion extends in the embodiment of FIG. 5 (A).

### DESCRIPTION OF THE PREFERRED EMBODIMENTS

Hereinafter, the explanation goes on for the content of the present invention using drawings, however, the present invention is not restricted to the embodiment shown by those drawings.

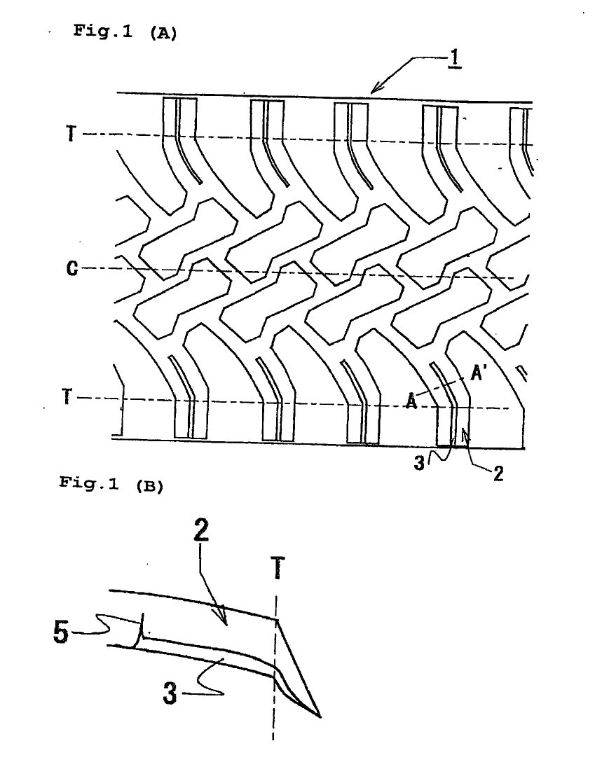

FIG. 1 (A) is a front elevation view of a tread pattern of a pneumatic tire of the present invention provided with protrusions, and the horizontal direction of FIG. 1 shows the tire circumferential direction and one dash chain at the position of C shows a center position, and the one dash chains at the both side positions T show the grounding edges.

The present invention relates to a technique used for a pneumatic tire with a block pattern (block tire). Although the present invention is particularly effective for a tire with square shoulders in which mud clogged in grooves that are present in a center side from a grounding edge among block tires is hard to be discharged, the effect of the present invention can also be shown in a tire with round shoulders. Among grooves that block out the blocks, in the present invention, at least one part of transverse groove 2 formed on a tread surface 1 goes over from the shoulder block to the grounding edge T and has an open edge in an outer side from said grounding edge T. At the bottoms of such transverse grooves 2, there are protrusions 3 that extend along the direction of the transverse grooves 2. These protrusions 3 have starting points that are in a center C side from the grounding edge T in a tire front view and go over said grounding edge T, and have terminal point in an outer side from said grounding edge T.

FIG. 1 (B) is a cross-section view along the direction that the protrusion extends in the embodiment of FIG. 1 (A).

FIG. 1 (C) is a cross-section view taken along A-A′ (a cross-section view vertical to the extending direction of the protrusions) in the embodiment of FIG. 1 (A).

Since the protrusions 3 extend in the outer side from the grounding edge T, the mud with fluidity adhering to the groove bottom of a center portion or a shoulder portion is guided by the protrusions 3 to the outer side of the grounding edge T and then the mud is discharged from the tread surface 1. When the mud is discharged from the groove bottom, traction performance as a tire is restored.

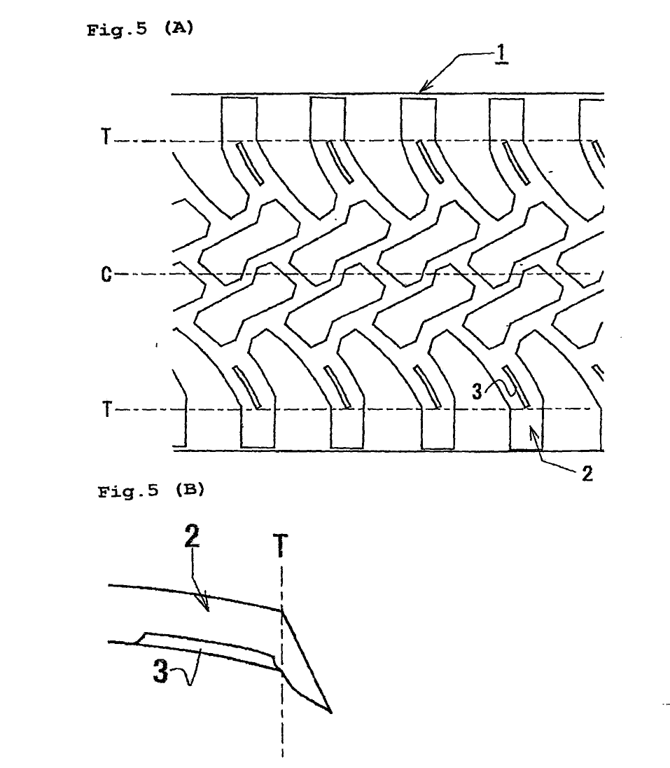

On the other hand, as shown in reference views such as the front elevation view of a tread pattern shown in FIG. 5 (A) or the cross-section view along the direction that the protrusions extend shown in FIG. 5 (B), when the protrusions do not extend to the grounding edge T although they exist at bottoms of the transverse grooves 2, the mud adhered to the groove bottom of the center portion or the shoulder portion get hard to be guided to the outer side of the grounding edge T and therefore, the discharging property of the mud once clogged is degraded.

In the present invention, the height of the protrusions 3 is preferably not less than 1 mm but not greater than 8 mm, and the further preferable range is 2 to 5 mm. The reason is that when the height exceeds 8 mm, mud discharging effect does not change greatly and the possibility of crack generation at the protrusion root tends to increase. When the height of the protrusions is less than 1 mm, the mud discharging effect of the present invention can hardly be shown. In addition, the width of the protrusions 3 is preferably 2 to 4 mm in general, although it changes depending on the width of the transverse grooves with protrusions provided. Further, the protrusions 3 preferably extend along the center line of the bottoms of the transverse grooves 2. Although the effect of the present invention can be shown even when the protrusions 3 do not extend along the center line of the bottoms of the transverse grooves but extend parallel to the center line of said transverse groove (so-called offset arrangement), on the other hand, the crack tends to be generated at the protrusion roots, which may cause the problem in durability.

Although the starting points of the protrusions 3 are arranged in a center C side from the grounding edge T as mentioned above, in particular, it is preferable to arrange the starting points 3 in the center C side by the length equivalent to 20 to 50% of a half of the tread width, making the grounding edge T in the side over which said protrusions 3 go as a base. When the starting points of the protrusions 3 are present in this range, in the case of the ordinary block pattern tread, the protrusions do not reach to the center block and depending on tread designs, since it is not so common that said protrusions transverse the main groove other than transverse grooves 2 that the protrusions 3 are present, it hardly affects the drainage property of the main groove in the tread circumferential direction. Further, it is because satisfactory mud discharge property can be secured for the main groove in the vicinity of center C as well. For information, the half of the tread width refers to the half the length of the width from one grounding edge T to the other grounding edge T.

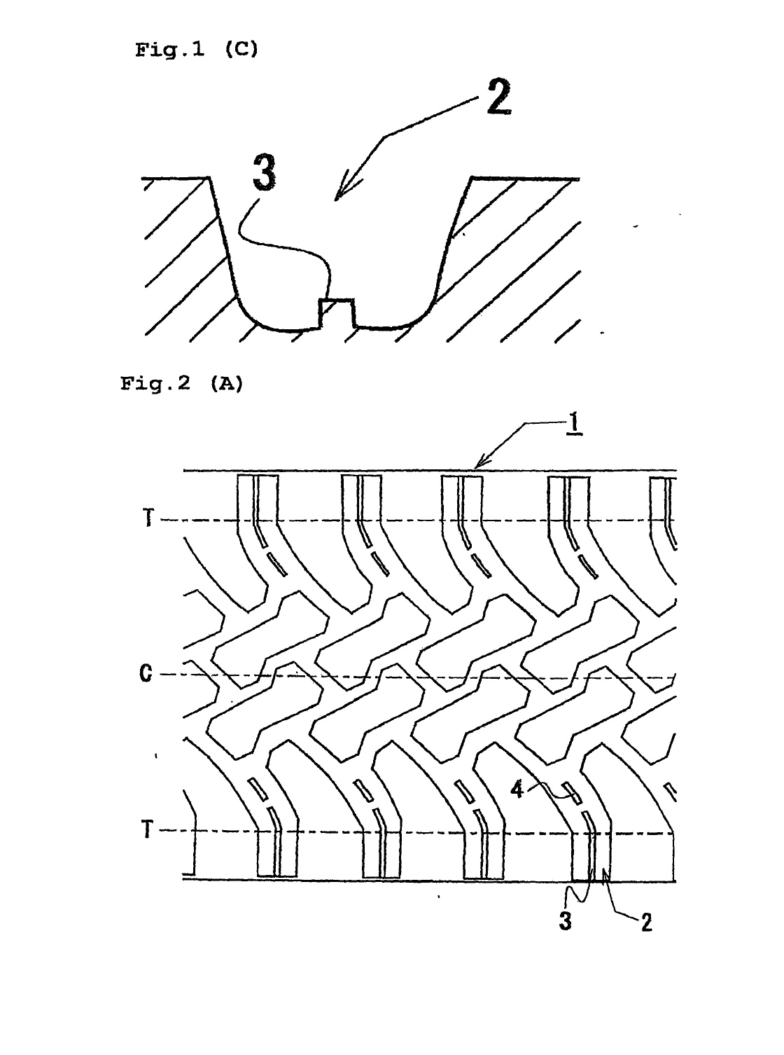

FIG. 2 (A) is a front elevation view of a tread pattern of a pneumatic tire with protrusions provided in another embodiment of the present invention. In the present embodiment, the protrusions 3 of said transverse grooves 2 have divided protrusions 4 that are formed dividedly in a center side from the grounding edge. Thus, it is preferable since the mud discharge property can be improved by dividing the protrusions 3, both the movement of the divided protrusions 4 and the left portions of the protrusions 3 that are divided get easier.

FIG. 2 (B) is a cross-section view along the direction that the protrusions extend in the embodiment of FIG. 2 (A).

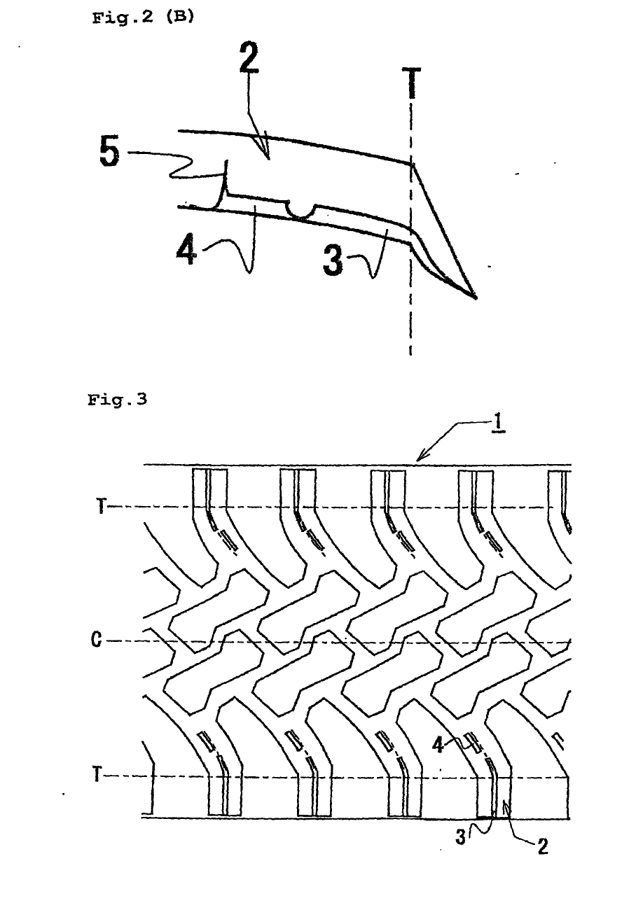

FIG. 3 is a front elevation view of a tread pattern of the pneumatic tire in another embodiment with the protrusions of the present invention formed. In the present embodiment, the protrusions 3 of said transverse grooves 2 have divided protrusions 4 that are formed dividedly in the center side from the grounding edge, and the left portions that are divided extend along the center line of the bottoms of said transverse grooves 2. On the other hand, the divided protrusions 4 are not along with the center line of the groove bottom (shown in two dash chains in FIG. 3), however, they extend parallel to the center line of the bottoms of said transverse grooves. In other words, seen from the left portions that are divided behind of the protrusions 3, the divided portions 4 are arranged by a so-called off set arrangement. When the transverse grooves 2 that have protrusions 3 at the groove bottom does not extend in the tire width direction and has some angles with tire width direction, as shown in FIG. 3, it is preferable that the divided protrusions 4 are off set so that the center C side becomes wider. With such an arrangement of the divided protrusions 4, the mud discharge property is enhanced. In addition, compared with when the whole protrusions 3 are not on the center line of the groove bottom and when they are arranged parallel to the center line of the groove bottom, there is little risk of crack generation at the root of the protrusions 3 and the divided protrusions 4.

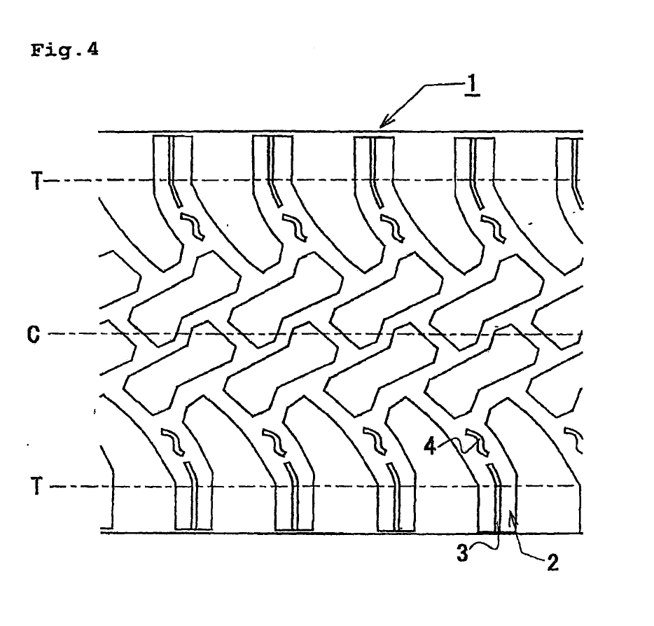

FIG. 4 is a front elevation view of the tread pattern of the pneumatic tire in another embodiment with the protrusions provided of the present invention. In the present embodiment, the protrusions 3 of said transverse grooves 2 are dividedly formed in the center side from the grounding edge, the protrusion 3 has divided protrusions 4, and the divided protrusions 4 are formed in S-shapes. For information, in the present invention, S-shapes include those that are mirror symmetrical with the character of S. Both shapes can show the effect of the invention. When the divided protrusions 4 is under off set arrangement as mentioned above, the possibility of generating cracks at the root becomes higher although not so high as when the whole protrusions 3 are under off-set arrangements. In this regard, when said divided protrusions 4 are formed in an S-shape, since the amount of offset to one side and the amount of offset to the other side cancel our each other, as the divided protrusions 4 as a whole, mud discharge property can be enhanced inhibiting the crack generation at the root of the divided protrusions 4 compared favorably with when the divided protrusions extend along the center line of the bottoms of said transverse grooves.

(Manufacturing Method)

Although the pneumatic tire of the present invention with protrusions 3 provided can be manufactured by providing grooves that correspond to said protrusions 3 in a tire mold, in order to form the protrusions with decreased level of defectiveness and high mud discharging property, it is preferable that vent holes are arranged at each position of the tire mold corresponding to the protrusion positions of the transverse grooves 2 and that the vulcanization molding of the pneumatic tire is performed by exhausting the residual air through said vent holes before and during the molding. When the pneumatic tire of the present invention is manufactured without exhausting the residual air at the position corresponding to the protrusions of the transverse grooves 2, as the unvulcanized rubber is pushed to the groove rib in the initial stage of vulcanization, an air pocket is generated in protrusions 3 and therefore, defective products are liable to be generated. Further, since the ridge line of the molded protrusion 3 tends to get round instead of formed sharply, sometimes it is inferior in mud discharge property.

It is preferable that the vent holes of said tire mold are provided at the position that corresponds to the ridge line in the center side of said protrusions. When the unvulcanized rubber is filled in the mold, since the flowing unvulcanized rubber is pushed in the early stage at the ridge line of the center side first among the portions of the protrusions 3, the timing that the pressure increases locally is earlier than other portions. Thus, when the vent holes are provided at the position that corresponds to said portion, the residual air can efficiently be exhausted in the early stage of filling of the unvulcanized rubber. In addition, in the embodiment of providing the divided protrusions 4, since said divided protrusions 4 are parts of the protrusions, the position that corresponds to the ridge line of the center side of the protrusions is also the position that corresponds to the ridge line of the center side of the divided protrusions. As long as it is the ridge line of the center side, the same effect as above can be obtained even when it is the ridge line of the divided protrusions.

However, as shown in FIG. 1 (B) or FIG. 2 (B), the generation of vent spew is inevitable at the position of the pneumatic tire that corresponds to the portion where the vent holes of said tire mold are provided. Even though said vent spew does not degrade the performance of the pneumatic tire, in order to maintain the appearance of the pneumatic tires to be shipped as products, it is preferable that the spew length is not greater than 8 mm and that the spew width is not greater than 1 mm. When the spew that exceeds this range is generated, the process of cutting said spew is required. Therefore, it is preferable that the vent holes of said tire mold are small whose diameter is not greater than 1 mm. It is more preferable that the diameter is around 0.6 mm, or 0.5 to 0.7 mm.

Further, considering the above mentioned characteristics from the opposite view point, it can be speculated that the pneumatic tire with vent spew remained or the cut trace thereof remained at each protrusion 3 is the pneumatic tire manufactured by the manufacturing method of the present invention.

### EXAMPLE

### Evaluation on Tire Performance

The tire size used for the test was LT265/75R16 16-7½ rim, and the tire with the inner pressure of 450 kPa was used. The half of the tread width of this tire was 106 mm. The width of the transverse groove is 25 mm and the protrusions with the width of 3 mm were provided at the bottoms of all the transverse grooves that stride the grounding edge.

The tires of Examples 1 to 9 and of Comparative Example 1 with different shapes, positions, and heights of said protrusions were prepared and on each of the tires, traction performance, mud discharge property, and cracking resistance at the protrusion root were evaluated. The characteristics of each of the tires are as follows.

### Example 1

In the pneumatic tire of Example 1, the continuous protrusions that extend along the center line of the bottoms of said transverse grooves as shown in FIG. 1 (A) were arranged. The starting points of the protrusions were arranged at the positions by 35% of the half of the tread width (37 mm from the grounding edge) from the grounding edge over which said protrusions stride, and the terminal points were arranged so that they are outer side from the grounding edge. Further, the protrusion heights were set to be 3 mm.

### Example 2

In the pneumatic tire of Example 2, the protrusions as shown in FIG. 2 (A) were provided. In other words, although the protrusions extend along the center line of the bottoms of said transverse grooves, the protrusions that extend along the center line with divided protrusions in a center side from the grounding edge were arranged. The starting points of the protrusions (that is, the starting points of the divided protrusions) were arranged at the position by 35% of the half of the tread width (37 mm from the grounding edge) from the grounding edge over which said protrusions stride, and the terminal points were arranged so that they are outer side from the grounding edge. Further, the protrusion heights were set to be 3 mm. Further, the length of the divided protrusions was set to be 16 mm, and the distance from said divided protrusions to the other protrusions was set to be 6.5 mm. Further, the heights of said divided protrusions were set to be 3 mm.

### Example 3

In the pneumatic tire of Example 3, the protrusions as shown in FIG. 3 were provided. That is, although the protrusions extend along the center line of the bottoms of said transverse grooves, the protrusions have divided protrusions in a center side from the grounding edge, and said divided protrusions were arranged by offset-moving by 1.5 mm in the tire rotational direction with respect to the center line of the bottoms of said transverse grooves. Other conditions were the same with those of Example 2.

### Example 4

In the pneumatic tire of Example 4, the protrusions as shown in FIG. 4 were provided. That is, although the protrusions extend along the center line of the bottom of said transverse grooves, the protrusions have divided protrusions in a center side from the grounding edge, and the protrusions with the divided protrusions formed in an S-shape were arranged. Other conditions were the same with those of Example 2.

### Example 5

In the pneumatic tire of Example 5, the protrusions with the same conditions as those of Example 2 except that the starting points of the protrusions (that is, the starting points of the divided protrusions) were arranged at the position in the half of the tread width by 20% (23 mm from the grounding edge) from the grounding edge over which said protrusions stride.

### Example 6

In the pneumatic tire of Example 6, the protrusions with the same conditions as those of Example 2 except that the starting points of the protrusions (that is, the starting points of the divided protrusions) were arranged at the position in the half of the tread width by 50% (53 mm from the grounding edge) from the grounding edge over which said protrusions stride.

### Example 7

In the pneumatic tire of Example 7, the protrusions with the same conditions as those of Example 2 except that the protrusion height was set to be 2 mm.

### Example 8

In the pneumatic tire of Example 8, the protrusions with the same conditions as those of Example 2 except that the protrusion height was set to be 5 mm.

### Example 9

In the pneumatic tire of Example 9, the protrusions with the same conditions as those of Example 2 except that the protrusion height was set to be 8 mm.

### Comparative Example 1

In the pneumatic tire of Comparative Example 1, the protrusions with the same conditions as those of Example 1 except that the protrusion terminal points are arranged in the center side by 6 mm from the grounding edge.

(Evaluation on Traction Performance)

Each of the pneumatic tires of Examples 1 to 9 and Comparative Example 1 were installed on a four-wheel-drive vehicle of a track-type (so-called a pickup truck) and having imparted a fixed load of 750 kg on a bed, accelerated evaluation driving 200 m on a muddy ground was made, the arrival time was measured, and the measured value was indexed letting the value of the Comparative Example 1 as a standard (100), thereby evaluating the traction performance. For information, the greater values show good traction performance.

(Evaluation on Mud Discharge Property)

After finishing the above mentioned evaluation on traction performance, driving 100 km on a paved road at a constant low speed, the tire weight was measured having cleaned tire side portions and rim portions, the value was indexed letting the value of the Comparative Example 1 as a standard (100), thereby evaluating the mud discharge property. For information, the greater values show good mud discharge property.

(Evaluation on Crack Resistance Property)

After driving 800 km on dirt circling course with each of the pneumatic tires of Examples 1 to 9 and Comparative Example 1, crack generation condition at the protrusion roots was inspected and the measured value was indexed letting the value of Comparative Example 1 a standard (100), thereby evaluating the crack resistance property. For information, the greater values show good crack resistance property (or, the smaller values show that the crack is more likely to be generated).

As heretofore mentioned, the results of the conditions of the protrusions and those of each performance evaluation of Examples 1 to 9 and Comparative Example 1 are shown in Table 1.

TABLE 1

| | | | | | Cracking |
|---|---|---|---|---|---|
| | Starting | Height of | Traction | Mud | resistance at |
| | position | protrusion | per- | discharge | protrusion |
| | (%) | (mm) | formance | property | part |
| Example 1 | 35 | 3 | 107 | 108 | 100 |
| Example 2 | 35 | 3 | 106 | 113 | 100 |
| Example 3 | 35 | 3 | 107 | 117 | 94 |
| Example 4 | 35 | 3 | 107 | 118 | 98 |
| Example 5 | 20 | 3 | 102 | 106 | 100 |
| Example 6 | 50 | 3 | 107 | 112 | 93 |
| Example 7 | 35 | 2 | 108 | 105 | 102 |
| Example 8 | 35 | 5 | 107 | 117 | 97 |
| Example 9 | 35 | 8 | 107 | 115 | 90 |
| Comparative | 35 | 3 | 100 | 100 | 100 |
| Example 1 | | | | | |

When the Comparative Example 1 and Example 1 are compared, it is found that both of the traction performance and the mud discharge property have been improved by the protrusions' extending to the outer side going over the grounding edge. When Examples 1 and 2 are compared, it is found that the mud discharge property has been improved since the protrusions come to move more easily by preparing them divided protrusions in a center side from the grounding edge. When Examples 2, 7, 8, and 9 are compared, it is found that the mud discharge property has been improved when the protrusion height is up to 5 mm, but that even when it is higher, there is no substantial change. It is also found that the traction performance does not depend much on the protrusion heights. It is found that the crack resistance performance gets worse as the protrusions get higher.

The reason that the traction performance does not depend much on the protrusion heights is considered that as the protrusions get higher, the protrusion rigidity becomes weaker and said protrusions are inclined.

When Examples 2, 5, and 6 are compared, it is found that as the starting points of the protrusions become further from the center side, traction performance and mud discharge property are degraded. On the other hand, it is found that when the starting points of the protrusions become closer to the center side, the mud discharge property is improved, but the crack resistance performance is degraded. Further, when Examples 2, 3, and 4 are compared, it is found that by forming the divided protrusions into an S-shape, both traction performance and mud discharge property can be improved, preventing the degradation of the crack resistance performance to the minimum.

(Evaluation on Tire Manufacturing Efficiency)

Under the condition that the outer pressure of the tire mold is almost the same with the atmosphere pressure, manufacturing (vulcanization) of a tire was performed, using a vulcanizing machine providing heat by a hot plate.

As a die for molding, the die (die 2) appropriately provided with vent holes for exhausting air on a tire design surface, and the tire mold (die 1) with vent holes added at the positions corresponding to the protrusions arranged at the bottoms of the transverse grooves in addition to the vent holes of said die 2 are used. For information, the vent holes added in the die 1 were provided at the position that corresponds to the ridge line of the center side of the protrusions and the diameter was set to be 0.6 mm.

Except that said each die for molding was used, making the other vulcanizing facilities and conditions identical, 100 pneumatic tires of Example 1 were manufactured. In addition, the residual air in the die for molding was automatically exhausted from the vent holes by the pressure of bladders with high temperature and high pressure instead of using forced exhaust. As a result, with the vulcanization using the die 1, no defective products were recognized by the air pocket in the tire. On the other hand, with the vulcanization using the die 2, 3 defective products were generated by the air pocket in the tire. In addition, the ridge lines sharply appeared in the pneumatic tire manufactured by the die 1, while the ridge lines in the pneumatic tire manufactured by the die 2 were round in 12 pneumatic tires including the 3 tires that had appearance defects.

1.-5. (canceled)

6. A manufacturing method of a pneumatic tire having block patterns with a plurality of blocks formed on a tire surface, wherein said pneumatic tire is provided with transverse grooves that open to a grounding edge in the tire width direction, and is provided with protrusions that extend along the direction of said transverse grooves at bottoms of said transverse grooves, in a tire front view, said protrusions have starting points in the center side from a grounding edge, which go over said grounding edge and have terminal points of the outer side from said grounding edge, that molds the pneumatic tire using a tire mold, the method comprising arranging vent holes at respective positions of the tire mold that correspond to the positions of the protrusions of the transverse grooves, and performing vulcanization molding of the pneumatic tire, exhausting the residual air before molding and during molding through said vent holes.

7. The manufacturing method of the pneumatic tire as set forth in claim 6, wherein the vent holes of said tire mold are provided at a position that corresponds to a ridge line of the center side of said protrusions.

8. The manufacturing method of the pneumatic tire as set forth in claim 6, wherein the diameter of the vent holes of said tire mold are not greater than 1 mm.
